(19) United States
(12) Patent Application Publication
(10) Pub. No.: US 2026/0371038 A1
(43) Pub. Date: Nov. 19, 2026

(54) IDENTITY SERVICES-MEDIATED SET UP OF AUXILIARY COMMUNICATION IN COMMUNICATION SESSION

(71) Applicant: APPLE INC., Cupertino, CA (US)

(72) Inventors: Preethi KONDURI, Cary, NC (US); Justin R ETZINE, San Jose, CA (US); Adam Y SYED, San Francisco, CA (US); Daniel B POLLACK, Cupertino, CA (US); Pierre J DE FILIPPIS, Los Gatos, CA (US); Yi XU, Sunnyvale, CA (US); Abigail Catriona SHILTS, San Diego, CA (US); Sean D HEFFERNAN, Santa Clara, CA (US)

(21) Appl. No.: 19/651,265

(22) Filed: Apr. 17, 2026

Related U.S. Application Data
(60) Provisional application No. 63/807,781, filed on May 18, 2025.

(51) Int. Cl. H04W 4/16; H04W 4/12

(52) U.S. Cl. CPC H04W 4/16; H04W 4/12

(57) ABSTRACT

Communication management techniques are disclosed for secure establishment of secondary communications for devices that already are engaged in a first communication. When two or more devices are engaged in communication and it is desired to develop additional communication session(s) between them, the devices may engage an identity services-mediated protocol to establish the additional session. For example, at a terminal where the second communication session is to be initiated, the first device may refer a handle of the second device to an identity service. In an embodiment, the handle may identify the second terminal for purposes of the first communication session. The identity service may communicate a request to the second device to establish the second communication session, which may include an identifier of the first device. If the request is accepted by the second device, the second communication session may be established between the devices.

### CLAIMS FOR PRIORITY

The present disclosure benefits from priority conferred by application s.n. 63/807,781, filed May 18, 2025, entitled “Identity Services-Mediated Set Up Of Auxiliary Communication In Communication Session,” the disclosures of which are incorporated herein in its entirety.

### BACKGROUND

The present disclosure relates to management of communication sessions for terminal devices and, in particular, to management of supplementary communication sessions when terminal devices already are engaged in a first communication session.

There are host of communication devices available to the consuming public. Telephones, smartphones, and many computers are available that engage in session-based communication between participants. Typically, such devices establish communication sessions using communication service providers, and the communication service providers govern the types of data (such as audio and/or video) that can be exchanged. In modern telephony services, for example, communication sessions typically carry spoken audio and/or captured video of session participants.

It may occur that participants to a communication session will desire to exchange data beyond the capabilities of their communication sessions. For example, it may occur that one participant to a session will desire to share content of an application that is executing on that participant’s device. To support this new data exchange, it may be necessary to establish a second communication session between the devices. Adding a new communication session can create uncertainty for the participants because of the risk that spoofing may occur. When the device of participant to a communication session receives a request to engage in another communication session, how can the device determine that the new request is from other participant to an ongoing communication session? Might the new communication session be requested by a “spoofing” party, who is not a participant to the communication session and with whom the participant does not want to accept data?

### BRIEF DESCRIPTION OF THE DRAWINGS

FIG. 1 is a diagram of a communication system according to an embodiment of the present disclosure.

FIG. 2 is a schematic diagram that illustrates implementation of call and share communication sessions in an exemplary application of the present disclosure.

FIG. 3 illustrates a method of managing communication sessions between two terminals according to an embodiment of the present disclosure.

FIG. 4 illustrates application of the method in an exemplary use case.

FIG. 5 is a block diagram illustrating architecture of a terminal according to an embodiment of the present disclosure.

### DETAILED DESCRIPTION

Embodiments of the present disclosure provide a communication management method that increases security of communications between devices engaged in communication. According to these embodiments, when two or more devices are engaged in communication and it is desired to develop additional communication session(s) between them, the devices may engage an identity services-mediated protocol to engage the additional session. For example, at a terminal where the second communication session is to be initiated, the first device may refer a handle of the second device to an identity service. In an embodiment, the handle may identify the second terminal for purposes of the first communication session. The identity service may communicate a request to the second device to establish the second communication session, which may include an identifier of the first device. If the request is accepted by the second device, the second communication session may be established between the devices.

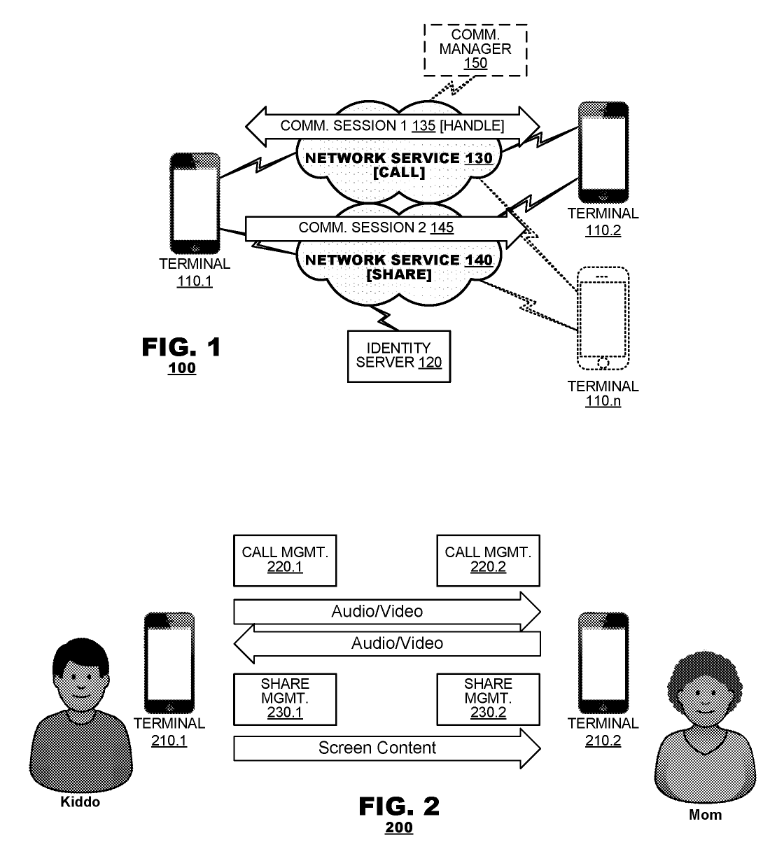

FIG. 1 is a diagram of a communication system 100 according to an embodiment of the present disclosure. The system 100 may include two or more terminals 110.1-110.n provided in mutual communication via one or more network services 130, 140. The terminals 110.1-110.n are shown in FIG. 1 as smartphones but the principles of the present disclosure find application with a variety of consumer communication devices such as tablet computers, personal computers, notebook computers and the like.

The communication system 100 may include an identity service server (“ISS”) 120. An ISS may employ protocols to establish secure communication connections between other devices to support a data exchange session. For example, at the time of this writing, Apple Corp., the assignee of the present disclosure, provides an identity service that employs protocols to support the FaceTime and iMessage services that are available on many iOS-based consumer products. Other providers of communication applications also may provide ISSs.

The terminals 110.1-110.n and ISS 120 may be provided in mutual communication by one or more communication networks. As discussed herein, the principles of the present disclosure extend a first communication session between two or more terminals (say, 110.1 and 110.2) to include a second communication session that is mediated by an ISS 120. For this purpose, FIG. 1 illustrates a first network service 130 that manages a first communication session 135 and a second network service 140 that carries data of the second communication session 145. While it is convenient to think of the call and share sessions as occurring on wholly different networks, it is not required that they do so. In appropriate applications, it may occur that the call and share sessions traverse common communication equipment of a common network.

For purposes of the present discussion, it is significant only that the terminals 110.1, 110.2, etc. of the first communication session have identifiers (called “handles,” for convenience) assigned to them for that communication session. The terminals 110.1, 110.2, etc. typically will be registered with a management entity (shown as a communication manger 150 in FIG. 1) that determines that the terminals 110.1, 110.2, etc. are entitled to access the network service 130 and, by extension, to establish a communication session 135 between them. By way of example, for terminals 110.1, 110.2, etc. that are engaged in a telephone call, the terminals 110.1, 110.2, etc. will have been registered with a telephony service provider and they will have been assigned telephone numbers. These telephone numbers can serve as handles for the purposes of the present discussion. In another example, the terminals (or users of the terminals) can have e-mail addresses assigned to them by an Internet services provider; the e-mail addresses can serve as handles purposes of the present discussion.

FIG. 2 is a schematic diagram that illustrates implementation of call and share communication sessions in an exemplary application of the proposed techniques. In this example, two parties (called “Kiddo” and “Mom,” in this example) engage in mutual communication between terminals 210.1 and 210.2 in two stages. In a first stage of their communication, the participants may engage in a call between their terminals 210.1, 210.2. The call session may cause a mutual exchange of audio data, video data, or both between the terminals 210.1, 210.2. In this first stage, audio captured by first terminal 210.1 may be coded and sent to the second terminal 210.2, where it is output to the second participant by an audio device, such as a terminal speaker (not shown), participant headphones (also not shown), or an analogous device. In a call that supports video exchange, video captured by the first terminal 210.1 also may be coded and sent to the second terminal 210.2 for output, for example, by rendering the video content on a display of the second terminal 210.2. In a call that supports bidirectional exchange, audio and/or video may be captured by the second terminal 210.2, the audio and/or video may be coded and sent to the first terminal 210.1, where it is decoded and output by the first terminal 210.1. Each terminal 210.1, 210.2 may operate according to respective call management software 220.1, 220.2, which controls operation of the call, for example, call setup, exchange of audio and/or video, and call tear down, and the call itself may be managed by communication services equipment (such as the communication manager 150 shown in FIG. 1).

The call management software 220.1, 220.2 may be represented as a daemon that executes within the software infrastructure of a terminal (say, terminal 210.1). The daemon may perform call control operations, such as interfacing with a communication services provider in the network to perform call setup and teardown, instantiating a user interface associated within the call, and managing terminal operation during the call. Typically, approved communication services providers will be registered with the call management software 220.1. Call setup also may include sending call set up requests to a service-based communication manager 150 and negotiating call management parameters with the communication manager 150 and/or far-end terminal(s) such as terminal 210.2, which may include, for example, negotiating coding parameters for audio and/or video that will be exchanged between the terminals 210.1, 210.2 during the call. The daemon further may apply call management based on operational settings of the terminal 210.1, for example, whether the terminal is in a “do not disturb” or other operational mode. In one implementation that uses the iOS infrastructure, the call management software 220.1 may include the iOS CallKit.

It may occur that a participant at one of the terminals (say, terminal 210.1) may desire to engage in a second communication session for purposes of sharing data from the first terminal 210.1 with the participant at the second terminal 210.2. In this circumstance, the first participant (Kiddo, in this example), may engage share management software 230.1 on the first terminal 210.1 to share content from the first terminal 210.1. When the second communication session is established, the first terminal 210.1 may code and transmit a representations of content displayed on the first terminal 210.1 to the second terminal 210.2, where it may be decoded and displayed to Mom, the second participant.

The share management software also may be represented as a daemon that executes within the software infrastructure of a terminal (again, terminal 210.1). The daemon may perform share management operations such as interfacing with an ISS 120 (FIG. 1) for purposes of share setup, share parameter negotiation, and share teardown. The share management software may read, from other elements of the terminal’s software infrastructure, content that is being displayed locally on the terminal 210.1. The share management software 230.1 may code representations of the displayed screen content for delivery to a far-end terminal 210.1. The share management software 230.1 also may instantiate a graphical user interface associated with the screen sharing session.

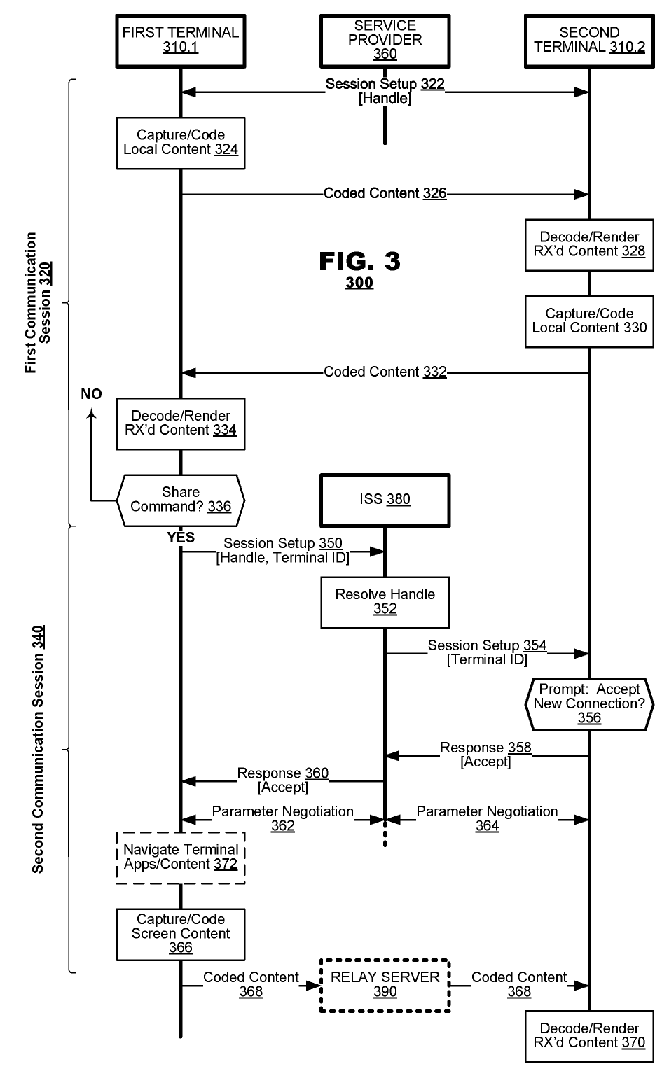

FIG. 3 illustrates a method 300 of managing communication sessions between two terminals 310.1, 310.2 according to an embodiment of the present disclosure. The method 300 may be performed to augment a first communication session 330 (shown as a call) with a second communication session 340 (shown as screen share management).

The first communication session 320 may begin with a session set up operation 322 that involves communication between the first and second devices 310.1, 310.2 and network infrastructure 360 such as a communication manager 150 (FIG. 1). For a telephony call, a first terminal (say, 310.1) may engage service provider call control elements 360 to locate and initiate communication with the second terminal 310.2. Once the second terminal 310.2 confirms acceptance of the call connection to the network 360, the first and second terminals 310.1, 310.2 may exchange signaling to define parameters of the call. Session setup operations 322 may proceed in a different sequence of operations for other types of communication services. Regardless of implementation, however, at some point, the first and second terminals 310.1, 310.2 will reach a state in which they exchange user data between them as part of the first session 320.

As part of the session setup operation, the terminals 310.1, 310.2 each may receive one or more handles of the counterpart terminals that participate in the first communication session 320. That is, the first terminal 310.1 may receive an identifier of the second terminal 310.2, and the second terminal 310.2 may receive an identifier of the first terminal 310.1. The identifier may be, for example, a telephone number of the counterpart device. The identifier may be provided to each terminal 310.1, 310.2 by the network 360. Alternatively, each terminal 310.1, 310.2 may provide an identifier to the other terminal 310.2, 310.1.

FIG. 3 illustrates basic operations to exchange user data between the terminals 310.1, 310.2, for example, audio and/or video of each participant to the first communication session 320. Starting with the first terminal 310.1, the first terminal 310.1 may capture local content at the terminal’s location (box 324). For example, a first terminal’s microphone (not shown) may capture audio at the first terminal’s location. Similarly, a camera (not shown) at the first terminal 310.1 may capture video at the first terminal’s location (if supported by the call service). The first terminal 310.1 may code the audio and/or video as appropriate for the session 320 and transmit the coded content to the second terminal 310.2 (box 326). The second terminal 310.2 may decode the coded data received from the first terminal 310.1 and render it locally at the second terminal 310.2 (box 328).

Similarly, the second terminal 310.2 may capture local content at the terminal’s location (box 330). Here, again, a second terminal’s microphone (not shown) may capture audio at the second terminal’s location. Similarly, a camera (not shown) at the second terminal 310.2 may capture video at the second terminal’s location, if supported by the session 320. The second terminal 310.2 may code the audio and/or video as appropriate for the call and transmit the coded content to the first terminal 310.1 (box 332). The first terminal 310.1 may decode the coded data received from the second terminal 310.2 and render it locally at the first terminal 310.1 (box 334).

At some point during the first communication session 320, one of the terminals (in this example, the first terminal 310.1) may receive a user command (box 336) to initiate sharing of content from the terminal 310.1. In response to the command, the terminal 310.1 may engage process steps associated with screen a second communication session 340, discussed below.

The operations of boxes 324-334 may be performed continually until the terminals 310.1, 310.2 end the first communication session 320. The terminals 310.1, 310.2 may exchange signaling with each other and with the service provider 360 to tear down the communication session 320 (communication flow not shown).

With respect to the second communication session 340, the terminal 310.1 may communicate a session setup request 350 to an ISS 380. The setup request may include the handle of the far-end terminal 310.2 that the terminal 310.1 received as part of the set up process for the first identity service. The set up request also may identify the first terminal 310.1.

The ISS 380 may resolve the handle of the far-end terminal 310.2 that it receives from the first terminals’ setup request 350. Assuming that the ISS recognizes the handle, it may communicate a session setup message 354 to the terminal 310.2 identified by the setup message. The set up message 354 may include the identifier of the first terminal 310.1 that the ISS 380 received in message 350. In response to the session setup message from the ISS 380, the second terminal 310.2 may prompt a user at the second terminal 310.2 whether to accept a new session. The prompt may provide the terminal identifier that the terminal 310.2 received from the ISS 380.

The second terminal 310.2 may provide a response message 358 to the ISS that identifies the user’s response to the prompt, and the ISS 380 may provide a response message 360 to the first terminal 310.1. When the new session is accepted, the ISS 380 may negotiate 362, 364 parameters of the second session 340 with the terminals 310.1, 310.2, including identification of a communication protocol to be used (whether RTMP or another protocol) parameters for encryption and coding of session data. Negotiation also include establishing a session via a relay server 390 through which data of the second communication may extend. At some point, the first and second terminals 310.1, 310.2 will reach a state in which they are ready to exchange user data between them as part of the second session 340.

The terminal 310.1 that is the source of the shared content (here, terminal 310.1) may capture and code content currently rendered on a display screen of the terminal (box 366) and may transmit the coded content to the second terminal (box 368). Transmission of the coded content may be performed directly from the first terminal 310.1 to the second terminal 310.2 or, if a relay server 390 is to be used, the transmission may traverse the relay server 390. The receiving terminal 310.2 may decode and render the content received from the source terminal 310.1. The operations of boxes 366-370 may be performed continually until the terminals 310.1, 310.2 end the second communication session (communication flow not shown). Of course, as the source terminal 310.1 provides screen content to the receiving terminal 310.2, a user of the source terminal 310.1 may navigate among different applications and content stored on the first terminal 310.1; such content would be shared with the receiving terminal 310.2 for as long as the second communication session 340 is active.

It is expected that the use of ISS 380 mediation to develop a second communication session 340 between participant terminals 310.1, 310.2 will provide a degree of protection against spoofing that might not be otherwise be present. As shown in FIG. 3, both terminals 310.1, 310.2 rely on ISS mediation to setup the second communication session 340, represented by messages 350 and 354. The ISS authenticates both terminals 310.1, 310.2 so that, when the receiving terminal 310.2 receives a setup request, the request is confirmed to have been received from a known reliable party, namely, the ISS. It can occur that, in other network environments, user identifiers can be spoofed; as one example, caller ID identifiers can be manipulated so that a call from an actor with one phone number appears to have a different phone number. Use of ISS mediation is proposed as a protection against such spoofing attempts.

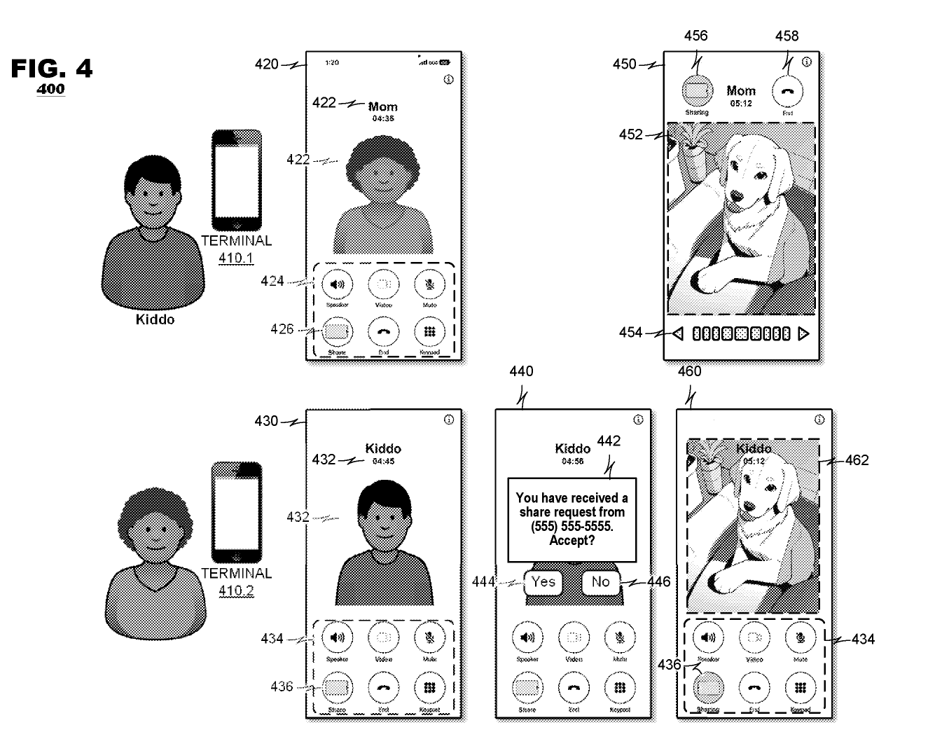

FIG. 4 illustrates application of the method 300 to session terminals 410.1, 410.2 in an exemplary use case. In the example of FIG. 4, the two participants of FIG. 2, Kiddo and Mom, will engage in first and second communication sessions 320, 340 (FIG. 3). Screens 420 and 430 illustrate exemplary screen output that may occur when the terminals 410.1, 410.2 are engaged in a first communication session 320. In this example, screen 420 may include an identifier 422 of the far-end participant, Mom, and it may possess a variety of user controls 424 for managing the call. One such control 426 may engage the second communication session functionality discussed here. Similarly, the screen 430 of terminal 410.2 may include an identifier 432 of the far-end participant, Kiddo, and it may possess a variety of user controls 434 for managing the call, including a control 436 to engage the second communication functionality discussed here. In the example of FIG. 4, the user controls 426, 436 for the second communication session 340 in screens 420 and 430 both have a state showing that the sharing functionality is inactive.

Screen 440 illustrates display of an exemplary prompt 442 (FIG. 3, box 356) at the second terminal 410.2. As discussed, the prompt 442 may display an identifier of the terminal 410.1 that is attempting to set up the second communication session between the terminals 410.1, 410.2. The prompt may include user controls 444, 446 that allow a user to accept or reject the proposed second communication session 340 (FIG. 3).

Screen 450 illustrates an exemplary display that might be presented at the first terminal 410.1 when the second communication session is 340 (FIG. 3) active. In this example, the terminal’s screen 450 is shown having a working area 452 where content of a currently-active application is being displayed. This working area may be captured as content to be shared with the far-end terminal 410.2 as part of the second communication session 340. In this example, the screen 450 is illustrated as having user controls 454 associated with the application and other user controls 456, 458 to control the first and second communication sessions 320, 340; the working area 452 may but need not be defined to exclude spatial areas of the screen associated with such controls 454, 456, 458. In other implementations, the method 300 (FIG. 3) simply may operate to capture and share content of the screen 450 in its entirety, without use of a working area 452.

In the example of FIG. 4, the user control 456 associated with the screen sharing function is shown having a state that indicates the first terminal 410.1 is performing outbound sharing, that is, the first terminal 410.1 is a source of content for the second communication session 340 (FIG. 3). Further interaction with the user control 456 may be interpreted by the first terminal 410.1 as a command to terminate the second communication session 340.

Screen 460 illustrates an exemplary display that might be displayed at a second terminal 410.2 when the second communication session is active. In this example, the screen shows content 462 received from the first terminal 410.1 via the second communication session 340 (FIG. 3). The screen 460 may possess a variety of user controls 434 for managing the call, including a control 436 for the second communication functionality. While the second communication session 340 is active, the user control 436 associated with the screen sharing function is shown having a state that indicates the second terminal 410.2 is performing inbound sharing, that is, the second terminal 410.2 is receiving content as part of the second communication session 340. Further interaction with the user control 436 may be interpreted by the second terminal 410.2 as a command to terminate the second communication session.

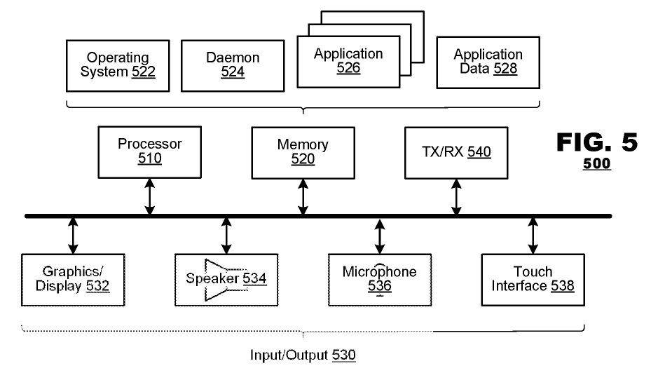

FIG. 5 is a block diagram illustrating architecture of a terminal 500 according to an embodiment of the present disclosure. The architecture illustrated in FIG. 5 may find application for the terminals in the foregoing discussion. The terminal 500 may include a processor 510, a memory system 520, input/output devices 530, and transceivers (shown as “TX/RX”) 540. The processor 510 may represent a central processing system of the terminal 500 which typically is provided by a multi-processor core for executing program instructions stored in memory 520. The memory system 520 may include electrical-, optical-, and/or magnetic storage devices (not shown) that store data representing program instructions and data to be processed by the processor 510. The program instructions may define a software architecture at work in the terminal, which may include an operating system 522, daemon 524, one or more applications 526, and application data 528.

The terminal 500 may include a variety of input/output devices 530. The terminal may include a display and a graphics processing system that generates display content to be output from the terminal 500 from data generated by the processor 510. The terminal 500 also may include a speaker and a microphone to capture audio and/or video content during communication sessions. And the terminal may include a touch screen interface to detect user interaction with content rendered on the display.

The transceivers 540 may interface the terminal 500 with the communication networks (FIG. 1) with which the terminal 500 operates. The transceivers 540 may format data to be exchanged with those networks according to governing protocols of those network and output the data from the terminal 500.

Several embodiments of the invention are specifically illustrated and/or described herein. However, it will be appreciated that modifications and variations of the invention are covered by the above teachings and within the purview of the appended claims without departing from the spirit and intended scope of the invention.

We claim:

1. A method, comprising:
while a first communication session is engaged between a pair of devices, receiving, at a first of the devices, a command to share content of the first device,
responsive to the command, referring a handle of a second device to the first communication session to an identity service,
responsive to an indication that the second device has accepted a request from the identity service of a second communication session between the first and second device, transmitting content from the first device to the second device via the second communication session.

2. The method of claim 1, wherein the handle is received from a network that manages the first communication session.

3. The method of claim 2, wherein the handle is a telephone number of the second terminal.

4. The method of claim 1, wherein the handle is an e-mail address associated with the second terminal.

5. The method of claim 1, wherein the first communication session is a telephone call.

6. The method of claim 1, wherein the handle is received from the second device as part of the first communication session.

7. The method of claim 1, wherein the transmitted content is content displayed on a display of the first device.

8. The method of claim 6, wherein the transmitted content is content of an application window displayed by the first device.

9. The method of claim 6, wherein the transmitted content is all content displayed by the first device.

10. The method of claim 1, further comprising, while the second communication session is active, transmitting content displayed on a display of the first device as a user navigates among application functionality of the first device.

11. The method of claim 1, wherein the transmitted content is content stored by the first device.

12. The method of claim 1, further comprising:
displaying a second session control on a user interface of the first device, and
terminating the second communication session upon user activation of the control.

13. A computer readable medium storing program instructions that, when executed by a processor of a first device, causes the first device to:
while a first communication session is engaged between the first device and a second device, receiving, at the first device, a command to share content of the first device,
responsive to the command, referring a handle of the second device to an identity service,
responsive to an indication that the second device has accepted a request from the identity service of a second communication session between the first and second device, transmitting content from the first device to the second device via the second communication session.

14. A method, comprising:
while a first communication session is engaged between a pair of devices, receiving, at a first of the devices from an identity service, a request to establish a second communication session between the pair of devices the request including data representing a handle of a second of the devices,
displaying, on a display of the first device, a prompt to engage in a second communication session, the prompt containing the handle,
responsive to a command accepting the second communication, engaging in the second communication session,
displaying on the second device, content shared by the first device pursuant to the second communication session.

15. The method of claim 14, wherein the handle is received from a communications manager that manages the first communication session.

16. The method of claim 15, wherein the handle is a telephone number of the second terminal.

17. The method of claim 15, wherein the handle is an e-mail address associated with the second terminal.

18. The method of claim 14, wherein the first communication session is a telephone call.

19. The method of claim 14, wherein the handle is received from the second device as part of the first communication session.

20. The method of claim 14, wherein the shared content is content displayed on a display of the second device.

21. The method of claim 20, wherein the shared content is content of an application window displayed by the second device.

22. The method of claim 20, wherein the shared content is all content displayed by the second device.

23. The method of claim 14, wherein the shared content is content stored by the second device.

24. The method of claim 20, wherein the shared content is displayed in an application window of the second device.

25. The method of claim 14, further comprising:
displaying a second session control on a user interface of the first device, and
terminating the second communication session upon user activation of the control.

26. A computer readable medium storing program instructions that, when executed by a processor of a first device, causes the first device to:
while a first communication session is engaged between the first device and a second device, receiving, at the first device and from an identity service, a request to establish a second communication session between the first device and the second device, the request including data representing a handle of the second device,
displaying, on a display of the first device, a prompt to engage in a second communication session, the prompt containing the handle,
responsive to a command accepting the second communication, engaging in the second communication session,
displaying on the second device, content shared by the first device pursuant to the second communication session.

27. A method, comprising:
while a first communication session is engaged between a pair of devices, receiving, at an identity server from a first of the devices, a request to establish a second communication session between the pair of devices the request including data representing a handle of a second of the devices,
sending a request to a second of the devices to initiate a second communication session between the pair of devices, the request including data representing a handle of the first device,
responsive to a request acceptance received from the second device, mediating establishment of the second communication session between the pair of devices.

28. The method of claim 27, wherein the handles represent identifiers of the devices associated with the first communication session.

29. The method of claim 28, wherein at least one handle is a telephone number of a respective terminal.

30. The method of claim 28, wherein at least one handle is an e-mail address of a respective terminal.

31. The method of claim 27, wherein the mediation includes exchanging encryption parameters between the terminals.

32. The method of claim 27, wherein the mediation includes exchanging image encoding parameters between the terminals.

33. The method of claim 27, wherein the mediation includes identification of a relay server to exchange data to be shared between the first and second device.
